(19) United States
(12) Patent Application Publication
(10) Pub. No.: US 2020/0299995 A1
(43) Pub. Date: Sep. 24, 2020

(54) USE OF SOUND DAMPENING MATERIAL FOR NOISE REDUCTION

(71) Applicant: Schlage Lock Company LLC, Carmel, IN (US)

(72) Inventors: Brian C. Eickhoff, Danville, IN (US); Steven Verderaime, Colorado Springs, CO (US); Aaron P. McKibben, Fishers, IN (US); Karen Bishop, Fairfield, OH (US)

(21) Appl. No.: 16/361,791

(22) Filed: Mar. 22, 2019

(51) Int. Cl. E05B 17/00; E06B 7/086; E05C 1/00; E05C 1/08

(52) U.S. Cl. CPC E05B 17/0045; E06B 7/086; E05B 1/0053; E05C 1/08; E05C 1/002

(57) ABSTRACT

Hardware for a door, latch assemblies, exit device assemblies, and jalousies are disclosed herein. Hardware for a door includes at least one component formed from a material configured to dampen sound produced in use of the hardware. An exit device assembly includes at least one component formed from a material configured to dampen sound produced in use of the exit device assembly. A jalousie includes at least one component formed from a material configured to dampen sound produced in use of the jalousie.

### TECHNICAL FIELD

The present disclosure generally relates to hardware for a door, latch assemblies, exit device assemblies, and jalousies, and more specifically, but not exclusively, to reducing noise produced during operation of door hardware, latch assemblies, exit device assemblies, and jalousies.

### BACKGROUND

Acoustic noise is becoming a growing concern in many different environments. In some settings, wall and/or door hardware may be a significant factor contributing to undesirable environmental noise. When a person enters or exits a room through a door, for example, door hardware may make loud, distracting, or otherwise undesirable noise. While many manufacturers have made efforts to reduce the noise generated by their hardware devices, certain devices nonetheless produce excess noise. Reducing the noise produced by hardware devices therefore remains an area of interest.

### SUMMARY

The present disclosure may comprise one or more of the following features and combinations thereof.

According to one aspect of the present disclosure, hardware for a door may include at least one component formed from a material configured to dampen sound produced in use of the hardware. The material may include at least one polymeric layer arranged between multiple metallic layers.

In some embodiments, the hardware may be a latch assembly and the material may include sound dampening steel. Additionally, in some embodiments, the hardware may include a second component, one of the at least one component and the second component may be a stationary component and the other of the at least one component and the second component may be movable relative to the stationary component, the material may be configured to dampen sound produced in response to interaction between the stationary component and the component movable relative to the stationary component in use of the hardware, and the material may include sound dampening steel.

In some embodiments, the stationary component may be a retainer or retaining plate. The component movable relative to the stationary component may be a latchbolt that is movable relative to the retainer or retaining plate between a retracted position, in which a portion of the latchbolt is spaced from the retainer or retaining plate, and an extended position, in which the portion of the latchbolt contacts the retainer or retaining plate. The retainer or retaining plate may be formed from the material.

In some embodiments, the hardware may be a cylindrical latch assembly. Additionally, in some embodiments, the hardware may include one of the following: a mortise latch assembly, a tubular latch assembly, an interconnected latch assembly, a rim latch assembly, or a cabinet latch assembly. Further, in some embodiments still, the hardware may include a third component formed from the material.

According to another aspect of the present disclosure, an exit device assembly for a door may include at least one component formed from a material configured to dampen sound produced in use of the exit device assembly. The material may include at least one polymeric layer arranged between multiple metallic layers.

In some embodiments, the material may include sound dampening steel. Additionally, in some embodiments, the exit device assembly may include a second component, one of the at least one component and the second component may be a stationary component and the other of the at least one component and the second component may be movable relative to the stationary component, the material may be configured to dampen sound produced in response to interaction between the stationary component and the component movable relative to the stationary component in use of the exit device assembly, and the material may include sound dampening steel.

In some embodiments, the stationary component may be included in or coupled to a bracket. The component movable relative to the stationary component may be a latchbolt that is movable relative to the bracket between a retracted position, in which the latchbolt has a first orientation relative to the bracket, and an extended position, in which the latchbolt has a second orientation relative to the bracket different from the first orientation. The bracket may be formed from the material. The exit device assembly may include a third component formed from the material.

According to yet another aspect of the present disclosure, a jalousie may include at least one component formed from a material configured to dampen sound produced in use of the jalousie. The material may include at least one polymeric layer arranged between multiple metallic layers.

In some embodiments, the material may include sound dampening steel. Additionally, in some embodiments, the jalousie may include a stationary component separate from the at least one component, the at least one component may include a plurality of components that are movable relative to the stationary component and formed from the material, the material may be configured to dampen sound produced in response to interaction between the stationary component and the plurality of components in use of the jalousie, and the material may include sound dampening steel. The plurality of components may include slats or blades that are pivotally coupled to the stationary component, and the slats or blades may be formed from the material.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a perspective view of one latch assembly configured for installation in a door;

FIG. 2 is a cross-sectional view of the latch assembly of FIG. 1 taken about line 2-2 with a latchbolt of the latch assembly in an extended position;

FIG. 3 is a cross-sectional view of the latch assembly similar to FIG. 2 with the latchbolt in a retracted position and certain features depicted in phantom;

FIG. 4 is a perspective view of another latch assembly configured for installation in a door;

FIG. 5 is a cross-sectional view of the latch assembly of FIG. 4 taken about line 5-5 with a latchbolt of the latch assembly in an extended position;

FIG. 6 is a cross-sectional view of the latch assembly similar to FIG. 5 with the latchbolt in a retracted position and certain features depicted in phantom;

FIG. 7 is a perspective view of an exit device assembly configured for installation in a door;

FIG. 8 is an auxiliary view of the exit device assembly of FIG. 7 with an auxiliary bolt of the exit device assembly in an extended position;

FIG. 9 is an auxiliary view of the exit device assembly similar to FIG. 8 with the auxiliary bolt in a retracted position and certain features depicted in phantom;

FIG. 10 is a perspective view of a jalousie with slats or blades thereof in one position relative to a frame of the jalousie; and

FIG. 11 is another perspective view of the jalousie of FIG. 10 with the slats or blades in another position relative to the frame.

### DETAILED DESCRIPTION OF ILLUSTRATIVE EMBODIMENTS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Further, with respect to the claims, the use of words and phrases such as “a,” “an,” “at least one,” and/or “at least one portion” should not be interpreted as limiting to only one such element, unless specifically stated to the contrary, and the use of phrases such as “at least a portion” and/or “a portion” should be interpreted as encompassing both embodiments including only a portion of such element and embodiments including the entirety of such element, unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It should be appreciated that the teachings of the present disclosure are applicable to, but not limited to, structures, devices, units, and/or assemblies included in, or otherwise embodied as, hardware for a door. As will be apparent from the discussion that follows, the door hardware may include latch assemblies, mortise latch assemblies, exit device assemblies, and jalousies. Of course, it should be appreciated that the door hardware may include other suitable devices.

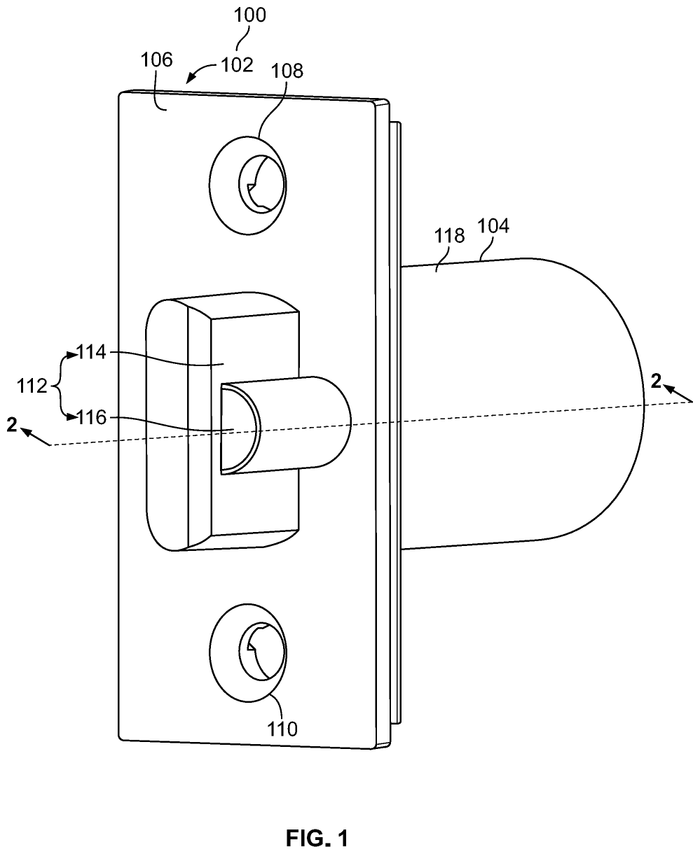

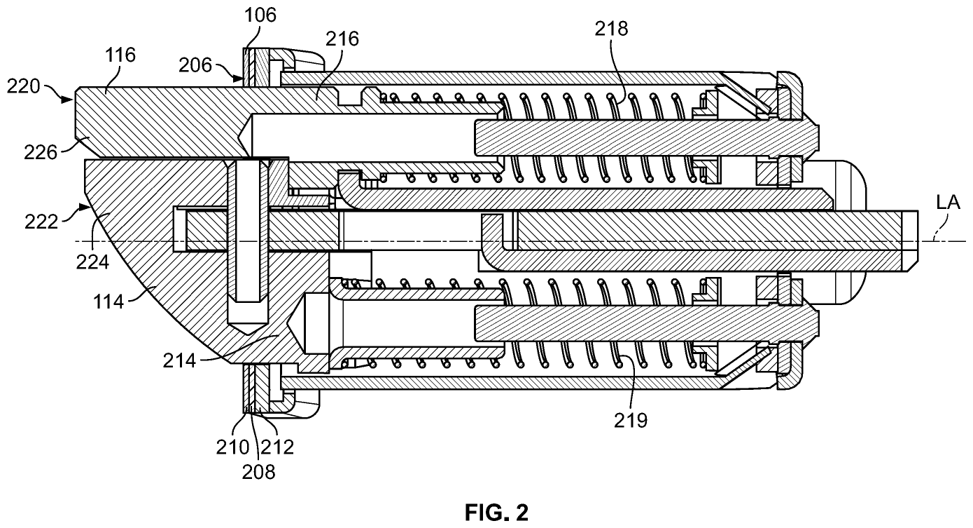

Referring now to FIG. 1, a latch assembly 100 is illustratively embodied as, or otherwise includes, a cylindrical-format latch assembly 102. As described in greater detail below, the cylindrical latch assembly 102 includes at least one component 106 that is formed from a material 206 (see FIG. 2) configured to dampen sound produced in use of the latch assembly 102. Consequently, compared to latch assemblies with components having constructions different from the at least one component 106, the illustrative latch assembly 102 may produce less noise than those latch assemblies. The material 206 includes at least one polymeric layer 208 arranged between metallic layers 210, 212, as further discussed below.

In the illustrative embodiment, the cylindrical latch assembly 102 has a lock cylinder 104 which may be operatively coupled to a door handle, and which may include a key lock. As would be understood by persons skilled in the art, the latch assembly 102 is sized for receipt in a cavity formed in a door (not shown). When the latch assembly 102 is received in the cavity, the latch assembly 102 may be mounted to the door using a retainer 106 thereof. Specifically, the retainer 106 may be mounted to an end of the door with fasteners or couplers (not shown), each of which may be received by one of apertures 108, 110 formed in the retainer 106. Upon being mounted in the door, a latch unit 112 of the latch assembly 102 is configured to interface with a strike plate provided on a door frame or another suitable structure.

The illustrative latch unit 112 includes a latchbolt or dead latchbolt 114 and a plunger or dead latch plunger 116. Each of the latchbolt 114 and the plunger 116 are at least partially received in a housing 118 of the lock cylinder 104, and each of the latchbolt 114 and the plunger 116 extends through the retainer 106 to interface with the strike plate or other suitable structure. It should be appreciated that when the latch unit 112 (i.e., the latchbolt 114 and/or the plunger 116) is received by an aperture defined in the strike plate such that the latch unit 112 contacts the strike plate, the latch assembly 102 prevents, or otherwise substantially resists, the door from being opened. It should also be appreciated that when the latch unit 112 does not contact the strike plate (e.g., when the latchbolt 114 and/or the plunger 116 are not received by the aperture defined in the strike plate), the latch assembly 102 permits opening of the door. In some embodiments, the latch unit 112 may be extended away from the retainer 106 and toward the strike plate to prevent the door from being opened by movement of the door handle, by movement of a key in the lock cylinder 104 and/or the key lock, or by an electronic signal which causes extension of the latch unit 112. In such embodiments, the latch unit 112 may be retracted toward the retainer 106 and away from the strike plate to permit opening of the door by movement of the door handle, by movement of a key in the lock cylinder 104 and/or the key lock, or by an electronic signal which causes retraction of the latch unit 112.

As would be apparent to persons skilled in the art, the illustrative cylindrical latch assembly 102 is configured for use in a variety of environments where noise reduction may be desirable. Examples of those environments include, but are not limited to, theaters, auditoriums, schools, libraries, dormitories, office buildings, cafeterias, commercial and/or residential spaces, and healthcare settings. Noise reduction may be of particular concern in healthcare settings such as hospitals, nursing homes, and mental health facilities, for example, where a loud environment may affect patient sleep and recovery times, lead to lower medical facility reimbursements, and contribute to loss of focus and errors of medical staff.

Referring now to FIG. 2, the plunger 116 is illustratively biased by a spring 218 toward an extended position 220, in which a portion 216 thereof contacts, abuts, and/or directly interfaces with the retainer 106. Similarly, the latchbolt 114 is illustratively biased by a spring 219 toward an extended position 222 in which a portion 214 thereof contacts, abuts, and/or directly interfaces with the retainer 106. When the plunger 116 is in the extended position 220, an end portion 226 thereof is spaced from the retainer 106 such that the plunger 116 extends beyond the plate 106 along a longitudinal axis LA. When the latchbolt 114 is in the extended position 222, an end portion 224 thereof is spaced from the retainer 106 such that the latchbolt 114 extends beyond the plate 106 along the axis LA.

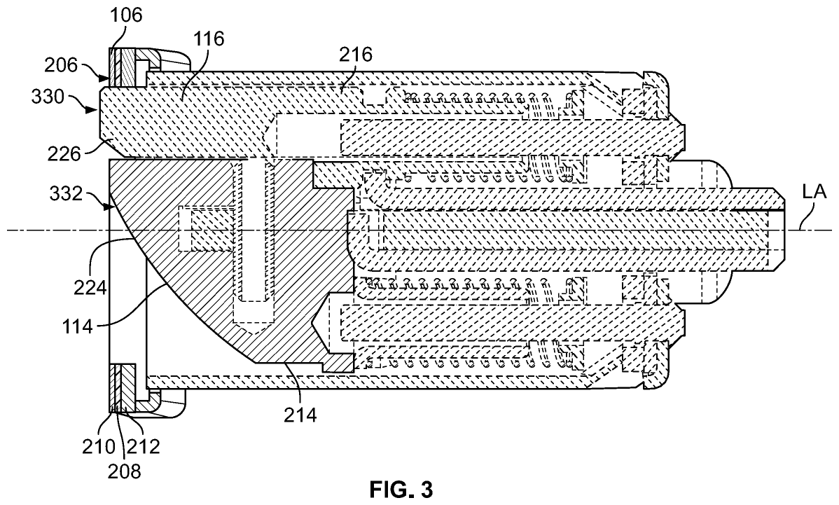

Referring now to FIG. 3, movement of the plunger 116 along the longitudinal axis LA toward the retainer 106 (i.e., to the right) overcomes the bias of the spring 218 such that the plunger 116 is in a retracted position 330. In the retracted position 330, the portion 216 is spaced from the retainer 106 and the end portion 226 is substantially aligned with the retainer 106 along the axis LA. Movement of the latchbolt 114 along the axis LA toward the retainer 106 (i.e., to the right) overcomes the bias of the spring 219 such that the latchbolt 114 is in a retracted position 332. In the retracted position 332, the portion 214 is spaced from the retainer 106 and the end portion 224 is substantially aligned with the retainer 106 along the axis LA. Of course, it should be appreciated that the plunger 116 and the latchbolt 114 may move between the respective extended positions 220, 222 and retracted positions 330, 332 in response to movement of the door handle, movement of a key in the lock cylinder 104 and/or the key lock, or receipt of an electronic signal by a controller (not shown) of the cylindrical latch assembly 102.

A number of features of the illustrative cylindrical latch assembly 102 are depicted in phantom in FIG. 3. It should be appreciated that the position(s) of certain features of the latch assembly 102 when the latchbolt 114 and the plunger 116 are in the respective extended positions 222, 220 may be different from the position(s) of those features when the latchbolt 114 and the plunger 116 are in the respective retracted positions 332, 330. Accordingly, for the sake of simplicity and ease of illustration, depiction of the features of the latch assembly 102 in phantom is intended to convey that the features may have position(s) different from the position(s) shown.

In the illustrative embodiment, the retainer 106 includes the material 206, as shown in FIGS. 2 and 3 and indicated above. Because the plate 106 is not entirely formed from metal (the material 206 includes the polymeric layer 208 as indicated above), the construction of the plate 106 facilitates noise reduction during operation of the cylindrical latch assembly 102, at least compared to other configurations that employ entirely metallic components throughout. More specifically, when the partially polymeric, stationary plate 106 interacts with the plunger 116 and/or the latchbolt 114, which are each movable relative to the plate 106 during operation of the latch assembly 102 as discussed above, the construction of the plate 106 is configured to dampen sound produced in response to interaction between the plate 106 and the plunger 116 and/or the latchbolt 114.

In the illustrative embodiment, the material 206 is embodied as, or otherwise includes, sound dampening steel. The illustrative polymeric layer 208 may be embodied as, or otherwise include, a viscoelastic polymeric layer. The illustrative metallic layers 210, 212 may each be embodied as, or otherwise include, a cold-rolled steel layer. In one example, the material 206 may be embodied as, or otherwise include, Quiet Steel® material manufactured by Material Sciences Corporation. Of course, in other embodiments, it should be appreciated that the material 206 may be embodied as, or otherwise include, another suitable sound dampening material that includes one or more polymeric layers arranged between multiple metallic layers. Furthermore, in other embodiments, the metallic layers 210, 212 may be formed from another suitable metallic material, and the polymeric layer 208 may be formed from another suitable polymeric material.

In some embodiments, one or more of the plunger 116 and the latchbolt 114 may be formed from the material 206. In such embodiments, the retainer 106, the plunger 116, and the latchbolt 114 may have substantially the same construction. In other embodiments, the retainer 106 may have an entirely metallic construction, and one or more of the plunger 116 and the latchbolt 114 may be formed from the material 206. In other embodiments still, one or more of the springs 218, 219 may be formed from the material 206. In such embodiments, the springs 218, 219 and the retainer 106 may have substantially the same construction.

It should be appreciated that the illustrative cylindrical latch assembly 102 may include components in addition to those described above. For example, the latch assembly 102 may include one or more plates, bars, linkages, rods, brackets, pins, balls, biasers, spacers, bearings, rings, shafts, gears, tabs, stops, receivers, pivots, clips, studs, races, hubs, retractors, actuators, guides, collars, or the like. In some embodiments, one or more of those additional components may be formed from the material 206 to dampen sound produced in response to movement (e.g., rattling) of those components in place, or in response to interaction with other components (e.g., as components move relative to one another).

Furthermore, it should be appreciated that in other embodiments, the latch assembly 102 may be embodied as, or otherwise include, another suitable latch assembly. In one example, the latch assembly 102 may be embodied as, or otherwise include, a tubular latch assembly. In another example, the latch assembly 102 may be embodied as, or otherwise include, an interconnected latch assembly. In yet another example, the latch assembly 102 may be embodied as, or otherwise include, a rim latch assembly. In yet another example still, the latch assembly 102 may be embodied as, or otherwise include, a cabinet latch assembly.

As should be apparent from the above description, the construction of one or more components of the illustrative cylindrical latch assembly 102 (i.e., from the material 206) facilitates, enables, or is otherwise associated with, noise reduction without the incorporation of entirely plastic components to dampen sound. That is, the latch assembly 102 does not include or require relatively soft (e.g., entirely plastic) components to be located along one or more paths of motion to effect noise reduction. Instead, one or more components of the latch assembly 102, which may be formed entirely from metal by stamping techniques in conventional configurations, are constructed from the material 206 to reduce noise as described above.

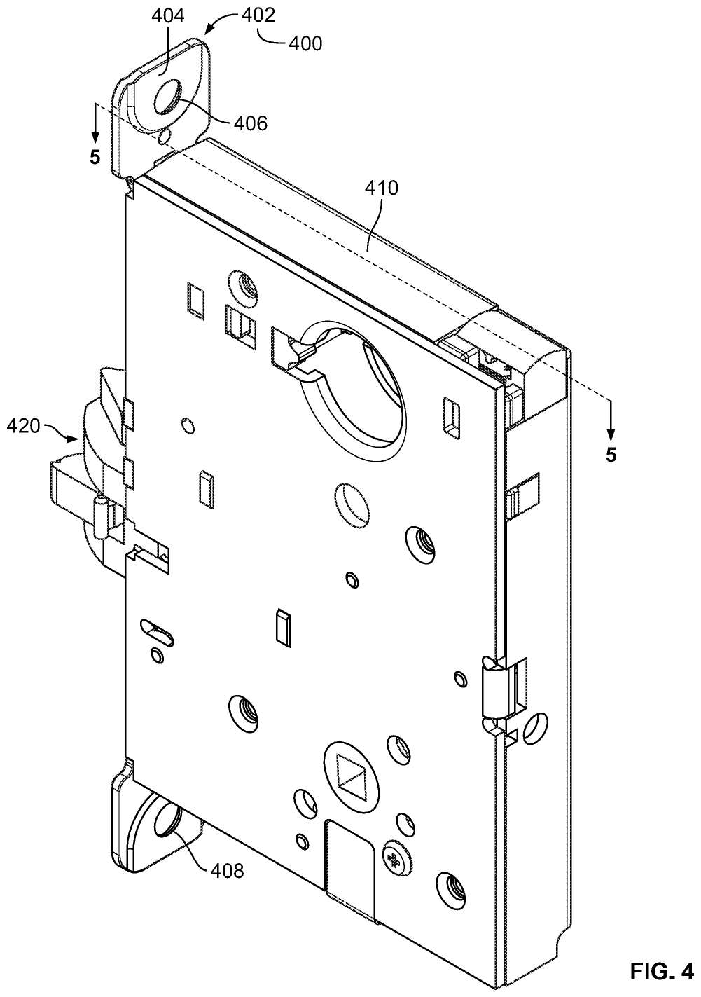

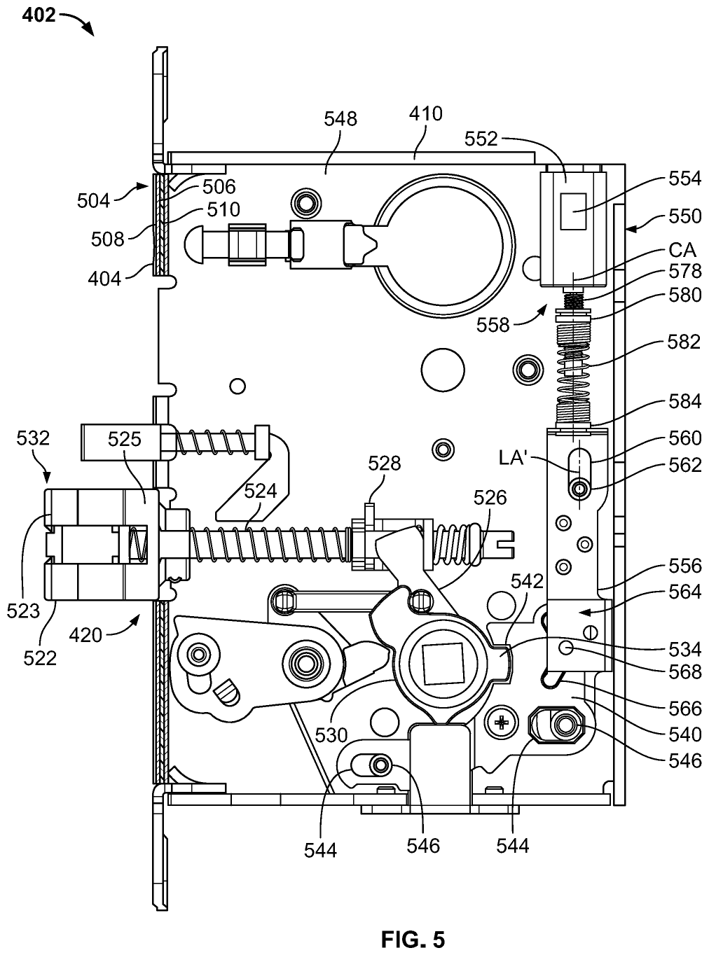

Referring now to FIG. 4, a latch assembly 400 is illustratively embodied as, or otherwise includes, a mortise latch assembly 402. As described in greater detail below, the mortise latch assembly 402 includes at least one component 404 that is formed from a material 504 (see FIG. 5) configured to dampen sound produced in use of the latch assembly 402. Consequently, compared to lock assemblies with components having constructions different from the at least one component 404, the illustrative latch assembly 402 may produce less noise than those lock assemblies. The material 504 includes at least one polymeric layer 506 arranged between metallic layers 508, 510, as further discussed below.

As would be apparent to persons skilled in the art, the illustrative mortise latch assembly 402 is configured for use in a variety of environments where noise reduction may be desirable. Examples of those environments include, but are not limited to, theaters, auditoriums, schools, libraries, dormitories, office buildings, cafeterias, commercial and/or residential spaces, and healthcare settings.

As would be understood by persons skilled in the art, a case 410 of the illustrative mortise latch assembly 402 is sized for receipt in a cavity formed in a door (not shown). When the latch assembly 402 is received in the cavity, the latch assembly 402 may be mounted to the door using an armor plate 404 thereof. Specifically, the armor plate 404 may be mounted to an end of the door with fasteners or couplers (not shown), each of which may be received by one of apertures 406, 408 formed in the armor plate 404. Upon being mounted in the door, a latch unit 420 of the latch assembly 402 is configured to interact with a feature provided on a door frame, such as a strike plate or other suitable structure.

Referring now to FIG. 5, in the illustrative embodiment, the mortise latch assembly 402 includes the latch unit 420, a hub 530 rotatably mounted in the case 410, a catch 540 slidably mounted in the case 410 and engageable with the hub 530, and a drive assembly 550 movable in the case 410 and operably coupled with the catch 540. As described in greater detail below, the drive assembly 550 is configured to drive movement of the catch 540 to cause the catch 540 to engage with, or disengage from, the hub 530, thereby driving extension or retraction of the latch unit 420. Of course, it should be appreciated that extension of the latch unit 420 such that the latch unit 420 contacts the strike plate or other suitable feature prevents, or otherwise substantially resists, the door from being opened, whereas retraction of the latch unit 420 such that the latch unit 420 does not contact the strike plate or other suitable feature permits opening of the door. In any case, certain features of the mortise latch assembly 402 may, for example, be of the type described in U.S. Pat. No. 4,583,382 to Hull, the contents of which are incorporated by reference herein in their entirety.

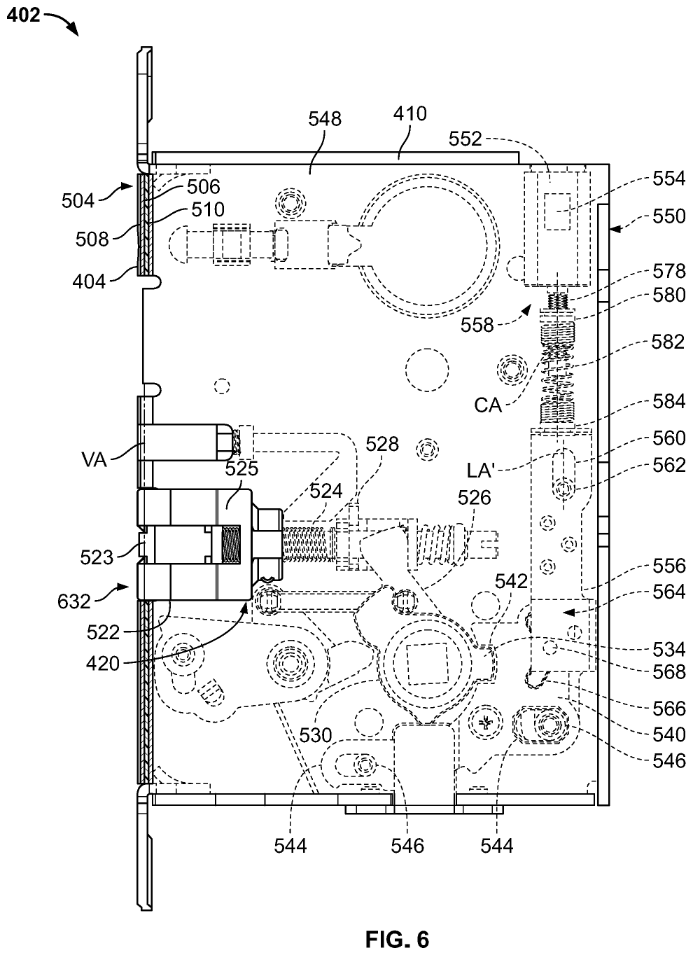

The illustrative latch unit 420 includes a latch bolt 522, a drive bar 524, a retractor 526, and a bracket 528. The latchbolt 522 is coupled to the drive bar 524 and the retractor 526 is coupled to the drive bar 524 via the bracket 528. The retractor 526 contacts, and is configured to rotate in response to rotation of, the hub 530. During operation of the latch unit 420, rotation of the hub 530 causes rotation of the retractor 526 and engagement between the retractor 526 and the bracket 528 drives lateral or translational movement of the drive bar 524. Movement of the drive bar 524 drives movement of the latchbolt 522 between an extended or latched position 532 and a retracted or unlatched position 632 (see FIG. 6). As would be apparent to persons skilled in the art, movement of the latchbolt 522 to the extended position 532 prevents opening of the door, whereas movement of the latchbolt 522 to the retracted position 632 permits opening of the door.

It should be appreciated that the hub 530 is rotationally coupled with an actuator (not shown) such as a lever, knob, or handle, for example, which is configured to drive movement of the latchbolt 522 when the hub 530 is free to rotate. Additionally, in some embodiments, the hub 530 may be coupled with an exterior actuator (not shown) on an unsecured side of the door, and another hub (not shown) may be coupled with an interior actuator on a secured side of the door. Of course, it should be appreciated that in other embodiments, the hub 530 may be configured to interact with both an exterior and an interior actuator. In any case, in the illustrative embodiment, the hub 530 includes a radial protrusion 534 that is configured to couple with the catch 540.

The illustrative catch 540 includes a recess 542 that is configured to receive the radial protrusion 534. In the illustrative embodiment, the catch 540 includes a slot 544 that is configured to receive a post 546 coupled to a backplate 548. The post 546 is substantially confined to lateral movement within the slot 544 such that the catch 540 is substantially confined to lateral movement between a locked position and unlocked position. Of course, in other embodiments, it should be appreciated that the catch 540 may be substantially confined to movement in the lateral direction by other features. Moreover, it should be appreciated that in other embodiments, the catch 540 may be movable between the locked position and the unlocked position in another suitable manner. For example, the catch 540 may be linearly movable between the locked position and the unlocked position in a longitudinal direction or in a direction angled with respect to the lateral direction and the longitudinal direction. Additionally, in some embodiments, the catch 540 may be configured to rotate during lateral movement between the locked position and the unlocked position.

During operation of the illustrative catch 540 in the unlocked position, the protrusion 534 is positioned outside of the recess 542 and the catch 540 is disengaged from the hub 530 such that the hub 530 is free to rotate. Consequently, the hub 530 may be driven for rotation by an actuator coupled thereto to cause movement of the latchbolt 522 to the retracted position 632. During operation of the catch 540 in the locked position, the protrusion 534 is received in the recess 542 such that the catch 540 is coupled or engaged with the hub 530. Engagement between the catch 540 and the hub 530 substantially prevents rotation of the hub 530 and substantially prevents retraction of the latchbolt 522 to the retracted position 632.

The illustrative drive assembly 550 includes a motor 552, a controller 554, a link 556, and a worm drive mechanism 558. The controller 554 is configured to control operation of the motor 552. The link 556 is mounted for sliding movement in the case 410 and contacts the catch 540. The worm drive mechanism 558 operably couples the link 556 with the motor 552 such that operation of the motor 552 drives movement of the link 556. As further described below, the worm drive mechanism 558 is configured to convert rotary motion of the motor 552 into longitudinal movement of the link 556 to drive movement of the catch 540 between the locked position and the unlocked position.

In the illustrative embodiment, the link 556 is slidable along a longitudinal axis LA′ defined by each of one or more slots 560. Each slot 560 is sized to receive a post 562 to substantially confine the post 562 to movement within the slot 560 along the axis LA′, and each post 562 is affixed to the backplate 548. Of course, it should be appreciated that in other embodiments, other features, devices, and/or systems may employed to constrain movement of the link 556 along the axis LA′. Additionally, it should be appreciated that in other embodiments, movement of the link 556 be may constrained along paths angled to the axis LA′.

The link 556 illustratively interfaces with the catch 540 via a guide or interface 564. In the illustrative embodiment, the guide 564 includes, or is otherwise embodied as, an angled slot 566 defined in the catch 540 and a pin 568 formed integrally with, or coupled to, the link 556. The slot 566 is sized to receive the pin 568 to guide movement of the link 556 relative to the catch 540. In use, the interface 564 enables, permits, or otherwise facilitates, movement of the link 556 (i.e., in a substantially longitudinal direction) to drive movement of the catch 540 (i.e., in a substantially lateral direction). Of course, it should be appreciated that in other embodiments, the guide 564 may be embodied as, or otherwise include, another suitable interface. Moreover, in some embodiments, no guide may be employed between the link 556 and the catch 540. In such embodiments, the link 556 may be affixed to, or pivotal relative to, the catch 540.

The illustrative worm drive mechanism 558 includes a shaft 578 having a worm, a shaft receiver 580, a helical spring 582, and a collared stud 584. The shaft 578 defines a central axis CA of the drive mechanism 558. The shaft receiver 580 and the spring 582 are configured to receive the shaft 578 and the spring 582 is configured to receive the shaft receiver 580 and the collared stud 584 such that the components 580, 582, 584 are coaxially arranged along the axis CA. The shaft 578 may be embodied as, or otherwise include, an output shaft of the motor 552, at least in some embodiments. Of course, in other embodiments, the shaft 578 may be coupled to an output shaft of the motor 552. The shaft receiver 580 is arranged between at least a portion of the shaft 578 and the spring 582 along the central axis CA, and the spring 582 is arranged between at least a portion of the shaft receiver 580 and the collared stud 584 along the axis CA. The collared stud 584 includes a circumferential channel that is sized to receive a flange or wall of the link 556 to operatively couple the stud 584 to the link 556, and the spring 582 is operatively coupled to the link 556 through the stud 584.

In use, due to engagement and/or interaction between the shaft 578 and the shaft receiver 580 (e.g., through threaded portions of each component 578, 580), rotation of the shaft 578 drives movement of the shaft receiver 580 along the axis CA. Movement of the shaft receiver 580 may be constrained by one or more features that prevent, or otherwise resist, rotation of the shaft receiver 580 about the axis CA. Movement of the shaft receiver 580 is illustratively transmitted through the spring 582 and the collared stud 584 to the link 556 such that the motor 552 drives movement of the link 556, the catch 540, the hub 530, and the latch unit 420 during operation of the mortise latch assembly 402.

In the illustrative extended position 532 of the latchbolt 522 shown in FIG. 5, the latchbolt 522 extends beyond the armor plate 404 such that an end portion 523 of the latchbolt 522 is located outside of the armor plate 404 and a portion 525 of the latchbolt 522 contacts, abuts, and/or directly interfaces with the plate 404. The location of the latchbolt 522 relative to the plate 404 in the extended position 532 permits, enables, or otherwise facilitates engagement and/or interaction between the latchbolt 522 and the strike plate or other suitable structure to prevent, or substantially resist, opening of the door.

Referring now to FIG. 6, in the illustrative retracted position 632 of the latchbolt 522, the latchbolt 522 is retracted toward the armor plate 404 such that the end portion 523 is not located outside of the plate 404 and the portion 525 does not contact, abut, and/or directly interface with the plate 404. Rather, the end portion 523 is located substantially linearly in-line with the armor plate 404 along a vertical axis VA and the portion 525 is spaced from the plate 404 in the retracted position 632. The location of the latchbolt 522 relative to the plate 404 in the retracted position 632 prevents, or substantially resists, engagement and/or interaction between the latchbolt 522 and the strike plate or other suitable structure to permit opening of the door.

A number of features of the illustrative mortise latch assembly 402 are depicted in phantom in FIG. 6. It should be appreciated that the position(s) of certain features of the latch assembly 402 when the latchbolt 522 is in the extended position 532 may be different from the position(s) of those features when the latchbolt 522 is in the retracted position 632. Accordingly, for the sake of simplicity and ease of illustration, depiction of the features of the latch assembly 402 in phantom is intended to convey that the features may have position(s) different from the position(s) shown.

In the illustrative embodiment, the armor plate 404 includes the material 504, as shown in FIGS. 5 and 6 and indicated above. Because the plate 404 is not entirely formed from metal (the material 504 includes the polymeric layer 506 as indicated above), the construction of the plate 404 facilitates noise reduction during operation of the mortise latch assembly 402, at least compared to other configurations that employ entirely metallic components throughout. More specifically, when the partially polymeric, stationary plate 404 interacts with the latchbolt 522, which is movable relative to the plate 404 during operation of the latch assembly 402 as discussed above, the construction of the plate 404 is configured to dampen sound produced in response to interaction between the plate 404 and the latchbolt 522.

In the illustrative embodiment, the material 504 is embodied as, or otherwise includes, sound dampening steel. The illustrative polymeric layer 506 may be embodied as, or otherwise include, a viscoelastic polymeric layer. The illustrative metallic layers 508, 510 may each be embodied as, or otherwise include, a cold-rolled steel layer. In one example, the material 504 may be embodied as, or otherwise include, Quiet Steel® material manufactured by Material Sciences Corporation. Of course, in other embodiments, it should be appreciated that the material 504 may be embodied as, or otherwise include, another suitable sound dampening material that includes one or more polymeric layers arranged between multiple metallic layers. Furthermore, in other embodiments, the metallic layers 508, 510 may be formed from another suitable metallic material, and the polymeric layer 506 may be formed from another suitable polymeric material.

In some embodiments, one or more components of the latch unit 420, the hub 530, the catch 540, and/or the drive assembly 550 may be formed from the material 504. In such embodiments, the armor plate 404 and the one or more components of the latch unit 420, the hub 530, the catch 540, and/or the drive assembly 550 may have substantially the same construction. In other embodiments, the armor plate 404 may have an entirely metallic construction, and the latchbolt 522 may be formed from the material 504. In other embodiments still, each of the armor plate 404 and the latchbolt 522 may be formed from the material 504.

It should be appreciated that the illustrative mortise latch assembly 402 may include components in addition to those described above. For example, the latch assembly 402 may include one or more plates, bars, linkages, rods, brackets, pins, balls, biasers, spacers, bearings, rings, shafts, gears, tabs, stops, receivers, pivots, clips, studs, races, hubs, retractors, actuators, guides, collars, or the like. In some embodiments, one or more of those additional components may be formed from the material 504 to dampen sound produced in response to movement (e.g., rattling) of those components in place, or in response to interaction with other components (e.g., as components move relative to one another).

Furthermore, it should be appreciated that in other embodiments, the latch assembly 402 may be embodied as, or otherwise include, another suitable latch assembly. In one example, the latch assembly 402 may be embodied as, or otherwise include, a tubular latch assembly. In another example, the latch assembly 402 may be embodied as, or otherwise include, an interconnected latch assembly. In yet another example, the latch assembly 402 may be embodied as, or otherwise include, a rim latch assembly. In yet another example still, the latch assembly 402 may be embodied as, or otherwise include, a cabinet latch assembly.

As should be apparent from the above description, the construction of one or more components of the illustrative mortise latch assembly 402 (i.e., from the material 504) facilitates, enables, or is otherwise associated with, noise reduction without the incorporation of entirely plastic components to dampen sound. That is, the latch assembly 402 does not include or require relatively soft (e.g., entirely plastic) components to be located along one or more paths of motion to effect noise reduction. Instead, one or more components of the latch assembly 402, which may be formed entirely from metal by stamping techniques in conventional configurations, are constructed from the material 504 to reduce noise as described above.

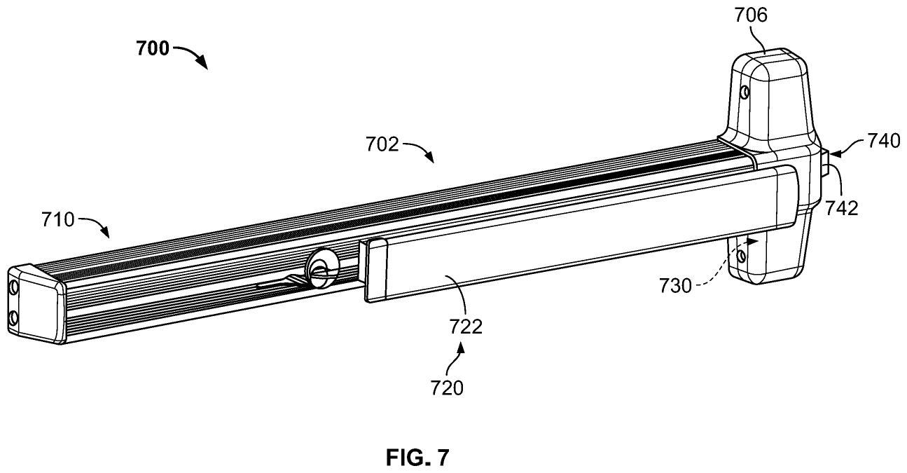

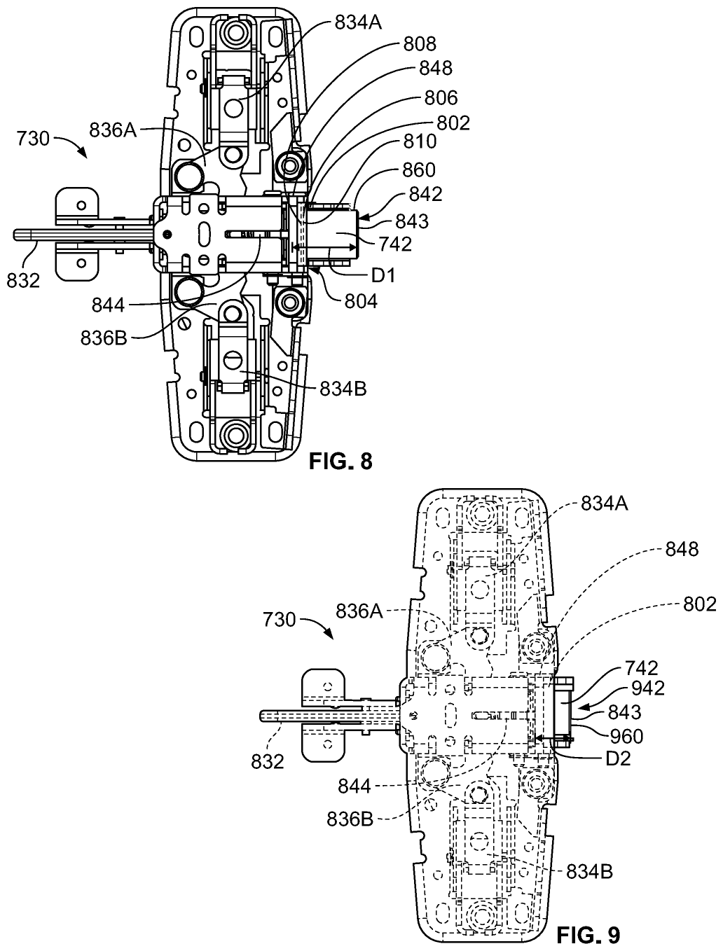

Referring now to FIG. 7, an illustrative exit device assembly 700 is configured for mounting to a door (not shown) to interact with a strike plate or other suitable structure mounted to, or otherwise provided by, a frame of the door. As described in greater detail below, the exit device assembly 700 includes at least one component 802 (see FIG. 8) that is formed from a material 804 configured to dampen sound produced in use of the exit device assembly 700. Consequently, compared to exit device assemblies with components having constructions different from the at least one component 802, the illustrative exit device assembly 700 may produce less noise than those devices. The material 804 includes at least one polymeric layer 806 arranged between metallic layers 808, 810, as further discussed below.

As would be apparent to persons skilled in the art, the illustrative exit device assembly 700 is configured for use in a variety of environments where noise reduction may be desirable. Examples of those environments include, but are not limited to, theaters, auditoriums, schools, libraries, dormitories, office buildings, cafeterias, commercial and/or residential spaces, and healthcare settings.

In the illustrative embodiment, the exit device assembly 700 includes a pushbar assembly 702 having a mounting assembly 710, a drive assembly 720, a latch control assembly 730, and a latch mechanism 740. The mounting assembly 710 is configured for mounting to the door. The drive assembly 720 includes a pushbar mechanism 722 that is configured to transition the drive assembly 720 between a de-actuated condition and an actuated condition to selectively actuate the latch control assembly 730. The latch control assembly 730 is configured to control operation of the latch mechanism 740 such that selective actuation of the latch control assembly 730 drives movement of a latch or latchbolt 742 of the latch mechanism 740 between an extended position 842 (shown in FIG. 8) and a retracted position 942 (shown in FIG. 9). As would be apparent to persons skilled in the art, when the latch 742 is in the extended position 842, the latch 742 is capable of contacting the strike plate or other suitable structure to prevent, or otherwise substantially resist, the door from being opened. When the latch 742 is in the retracted position 942, the latch 742 is spaced from the strike plate or other suitable structure to permit opening of the door.

In the illustrative embodiment, the latch mechanism 740 is housed by a header case 706. Of course, it should be appreciated that in other embodiments, the latch mechanism 740 may take another suitable form and/or be housed by another suitable structure. In some embodiments, the exit device assembly 700 may include a remote latching assembly having one or more remote latch mechanisms in addition to, or in lieu of, the illustrative mechanism 740. Such remote latch mechanisms may be provided as one or more top latch mechanisms each configured to engage the top jamb of a door frame, and/or as one or more bottom latch mechanisms each configured to engage the floor, for example. The latch control assembly 740 may further include one or more connectors, such as rods or cables, for example, and the one or more connectors may operably couple components (e.g., the connector links 834A, 834B described below) with the one or more remote latch mechanisms. In such embodiments, movement of the components in a laterally-inward retracting direction (i.e., toward one another) may serve to actuate the remote latch mechanisms.

Referring now to FIG. 8, the illustrative latch control assembly 730 includes a longitudinally-sliding control link 832 and laterally-sliding connector links 834A, 834B. The connector links 834A, 834B are coupled to the control link 832 by respective pivot cranks 836A, 836B. In some embodiments, the latch control assembly 730 may include a fork link (not shown) or other suitable feature that is coupled between the control link 832 and the drive assembly 720. In such embodiments, the fork link or other suitable feature may be connected to the drive assembly 720 such that actuation of the drive assembly 720 causes actuation of the latch control assembly 730.

The illustrative latch mechanism 740 includes the latch 742 and a retractor 844. The latch 742 is pivotally coupled to a header bracket 802 of the latch mechanism 740 by a pivot pin 848 to permit the latch 742 to pivot relative to the bracket 802 between the extended position 842 and the retracted position 942. The retractor 844 is coupled between the control link 832 and the latch 742 and configured to drive movement of the latch 742 between the positions 842, 942 in response to selective actuation of the latch control assembly 730. In some embodiments, the latch 742 may be biased toward the extended position 842 by a biasing element (not shown) such as a spring, for example.

In cooperation with one or more components, the control link 832, the connector links 834A, 834B, and the pivot cranks 836A, 836B illustratively control operation of the latch control assembly 730 such that those components may be said to be control components of the latch control assembly 730. Each of the control components is movable between one position (e.g., an extended position) and another position (e.g., a retracted position). Each control component is configured for movement (e.g., between the extended and retracted positions) in response to selective actuation of the drive assembly 720. Of course, it should be appreciated that the direction(s) of extension and retraction for one of the control components may be different from another of the components. For example, in some embodiments, the control link 832 may move between various positions in the horizontal or longitudinal direction, whereas the connector links 834A, 834B may move between various positions in the vertical or lateral direction.

In the illustrative embodiment, the control components are operationally coupled with one another for joint movement between the various positions thereof. Consequently, movement of one control component is associated with corresponding movement of another control component, and an increase/decrease in the speed at which one of the components moves is associated with a corresponding increase/decrease in the movement speed of another of the components. Additionally, in the illustrative embodiment, the latch 742 and the retractor 844 are operationally coupled with one another for joint movement between the various positions thereof. In some embodiments, the latch 742 and the retractor 844 may be operationally coupled with the control components via a lost motion connection (not shown) that enables the latch 742 to move between the extended and retracted positions 842, 942 without corresponding movement of the components.

In the illustrative extended position 842 of the latch 742 shown in FIG. 8, the latch 742 has an orientation 860 relative to the header bracket 802. In the orientation 860, an end portion 843 of the latch 742 is spaced from the pivot pin 848 by a distance D1. The orientation 860 of the latch 742 relative to the bracket 802 permits, enables, or otherwise facilitates engagement and/or interaction between the latch 742 and the strike plate or other suitable structure to prevent, or otherwise substantially resist, opening of the door.

Referring now to FIG. 9, in the illustrative retracted position 942 of the latch 742, the latch 742 has an orientation 960 relative to the header bracket 802 that is different from the orientation 860. In the orientation 960, the end portion 843 of the latch 742 is spaced from the pivot pin 848 by a distance D2 that is less than the distance D1. The orientation 960 of the latch 742 relative to the bracket 802 prevents, or otherwise substantially resists, engagement and/or interaction between the latch 742 and the strike plate or other suitable structure to permit opening of the door.

A number of features of the illustrative exit device assembly 700 are depicted in phantom in FIG. 9. It should be appreciated that the position(s) of certain features of the exit device assembly 700 when the latch 742 is in the extended position 842 may be different from the position(s) of those features when the latch 742 is in the retracted position 942. Accordingly, for the sake of simplicity and ease of illustration, depiction of the features of the exit device assembly 700 in phantom is intended to convey that the features may have position(s) different from the position(s) shown.

It should be appreciated that the latch 742 is configured for interaction with the bracket 802 during movement of the latch 742 between the extended and retracted positions 842, 942. In the illustrative embodiment, the bracket 802 includes the material 804, as shown in FIG. 8 and indicated above. Because the bracket 802 is not entirely formed from metal (the material 804 includes the polymeric layer 806 as indicated above), the construction of the bracket 802 facilitates noise reduction during operation of the exit device assembly 700, at least compared to other configurations that employ entirely metallic components throughout. More specifically, when the partially polymeric, stationary bracket 802 interacts with the latch 742, which is movable relative to the bracket 802 during operation of the exit device assembly 700 as discussed above, the construction of the bracket 802 is configured to dampen sound produced in response to interaction between the bracket 802 and the latch 742.

In the illustrative embodiment, the material 804 is embodied as, or otherwise includes, sound dampening steel. The illustrative polymeric layer 806 may be embodied as, or otherwise include, a viscoelastic polymeric layer. The illustrative metallic layers 808, 810 may each be embodied as, or otherwise include, a cold-rolled steel layer. In one example, the material 804 may be embodied as, or otherwise include, Quiet Steel® material manufactured by Material Sciences Corporation. Of course, in other embodiments, it should be appreciated that the material 804 may be embodied as, or otherwise include, another suitable sound dampening material that includes one or more polymeric layers arranged between multiple metallic layers. Furthermore, in other embodiments, the metallic layers 808, 810 may be formed from another suitable metallic material, and the polymeric layer 806 may be formed from another suitable polymeric material.

In some embodiments, one or more components of the pushbar assembly 702, the mounting assembly 710, the drive assembly 720, the latch control assembly 730, and the latch mechanism 740 may be formed from the material 804. In such embodiments, the bracket 802 and the one or more components of the pushbar assembly 702, the mounting assembly 710, the drive assembly 720, the latch control assembly 730, and the latch mechanism 740 may have substantially the same construction. In other embodiments, the bracket 802 may have an entirely metallic construction, and the latch 742 may be formed from the material 804. In other embodiments still, each of the bracket 802 and the latch 742 may be formed from the material 804.

It should be appreciated that the illustrative exit device assembly 700 may include components in addition to those described above. For example, the exit device assembly 700 may include one or more plates, bars, linkages, rods, brackets, pins, balls, biasers, spacers, bearings, rings, shafts, gears, tabs, stops, receivers, pivots, clips, studs, races, hubs, retractors, actuators, guides, collars, or the like. In some embodiments, one or more of those additional components may be formed from the material 804 to dampen sound produced in response to movement (e.g., rattling) of those components in place, or in response to interaction with other components (e.g., as components move relative to one another).

As should be apparent from the above description, the construction of one or more components of the illustrative exit device assembly 700 (i.e., from the material 804) facilitates, enables, or is otherwise associated with, noise reduction without the incorporation of entirely plastic components to dampen sound. That is, the exit device assembly 700 does not include or require relatively soft (e.g., entirely plastic) components to be located along one or more paths of motion to effect noise reduction. Instead, one or more components of the exit device assembly 700, which may be formed entirely from metal by stamping techniques in conventional configurations, are constructed from the material 804 to reduce noise as described above.

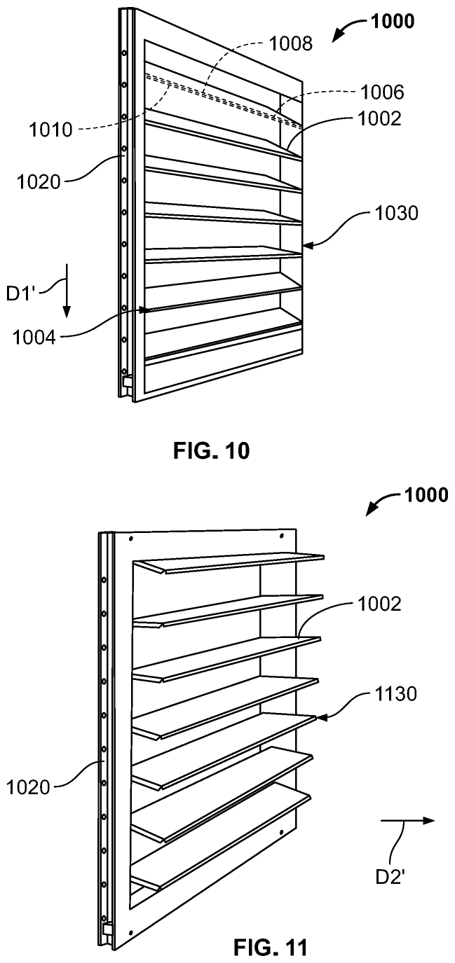

Referring now to FIG. 10, an illustrative jalousie or jalousie window 1000 is configured for mounting in a support structure such as a wall or a door, for example. As would be apparent to those skilled in the art, in some embodiments, the jalousie 1000 may be embodied as, or otherwise include, a louver or louver window. In any case, as described in greater detail below, the jalousie 1000 includes at least one component 1002 that is formed from a material 1004 configured to dampen sound produced in use of the jalousie 1000. Consequently, compared to jalousies and/or louvers with components having constructions different from the at least one component 1002, the illustrative jalousie 1000 may produce less noise than those devices. The material 1004 includes at least one polymeric layer 1006 arranged between metallic layers 1008, 1010, as further discussed below.

As would be apparent to persons skilled in the art, the illustrative jalousie 1000 is configured for use in a variety of environments where noise reduction may be desirable. Examples of those environments include, but are not limited to, theaters, auditoriums, schools, libraries, dormitories, office buildings, cafeterias, commercial and/or residential spaces, and healthcare settings.

In the illustrative embodiment, the jalousie 1000 includes a frame 1020 and slats or blades 1002. The frame 1020 is configured for mounting in a support structure such that the frame 1020 is a stationary component. The slats 1002 are coupled to the frame 1020 and each movable relative thereto. More specifically, each of the slats 1002 is pivotally coupled to the frame 1020 for pivotal movement between a relatively closed position 1030 and a relatively open position 1130 (see FIG. 11).

In some embodiments, the slats 1002 may be coupled to one another for common pivotal movement relative to the frame 1020. That is, the slats 1002 may be coupled together such that the slats 1002 move between the relatively closed position 1030 and the relatively open position 1130 in unison. In such embodiments, the slats 1002 may be coupled together via one or more tracks, guides, or the like, for example.

In some embodiments, the jalousie 1000 may include one or more adjustment mechanisms (not shown) configured to adjust the position of the slats 1002 between the relatively closed position 1030 and the relatively open position 1130. In such embodiments, each of the one or more adjustment mechanisms may be embodied as, or otherwise include, one or more cranks, pulleys, levers, linkages, transmissions, handles, guides, actuators, rods, brackets, pins, or the like.

In the illustrative relatively closed position 1030 of the jalousie 1000 shown in FIG. 10, the slats 1002 extend in a generally downward direction D1′. In some embodiments, in the relatively closed position 1030, the slats 1002 generally block, limit, or otherwise restrict the flow of air or light through the jalousie 1000 and between the slats 1002.

Referring now to FIG. 11, in the illustrative relatively open position 1130 of the jalousie 1000, the slats 1002 extend in a generally outward direction D2′ from the frame 1020. In some embodiments, in the relatively open position 1130, the slats 1002 generally permit the flow of air or light through the jalousie 1000 and between the slats 1002. That is, in the position 1130, the slats 1002 generally permit the flow of air or light through the jalousie 1000 and between the slats 1002 to a greater degree than when the slats 1002 are in the position 1030.

It should be appreciated that the slats 1002 are configured for interaction with the frame 1020 during movement of the slats 1002 between the positions 1030, 1130. In the illustrative embodiment, each of the slats 1002 includes the material 1004, as shown in FIG. 10 and indicated above. Because the slats 1002 are not entirely formed from metal (the material 1004 includes the polymeric layer 1006 as indicated above), the construction of the slats 1002 facilitates noise reduction during operation of the jalousie 1000, at least compared to other configurations that employ entirely metallic components throughout. More specifically, when the partially polymeric slats 1002 interact with the frame 1020, the construction of the slats 1002 is configured to dampen sound produced in response to interaction between the slats 1002 and the frame 1020.

In the illustrative embodiment, the material 1004 is embodied as, or otherwise includes, sound dampening steel. The illustrative polymeric layer 1006 may be embodied as, or otherwise include, a viscoelastic polymeric layer. The illustrative metallic layers 1008, 1010 may each be embodied as, or otherwise include, a cold-rolled steel layer. In one example, the material 1004 may be embodied as, or otherwise include, Quiet Steel® material manufactured by Material Sciences Corporation. Of course, in other embodiments, it should be appreciated that the material 1004 may be embodied as, or otherwise include, another suitable sound dampening material that includes one or more polymeric layers arranged between multiple metallic layers. Furthermore, in other embodiments, the metallic layers 1008, 1010 may be formed from another suitable metallic material, and the polymeric layer 1006 may be formed from another suitable polymeric material.

In some embodiments, one or more additional components of the jalousie 1000 may be formed from the material 1004. For example, in one such embodiment, the frame 1020 may have substantially the same construction as the slats 1002 such that the components 1002, 1020 are each formed from the material 1004. In other embodiments, the slats 1002 may each have an entirely metallic construction, and the frame 1020 may be formed from the material 1004.

It should be appreciated that the illustrative jalousie 1000 may include components in addition to those described above. For example, the jalousie may include one or more plates, bars, linkages, rods, brackets, pins, balls, biasers, spacers, bearings, rings, shafts, gears, tabs, stops, receivers, pivots, clips, studs, races, hubs, retractors, actuators, guides, collars, or the like. In some embodiments, one or more of those additional components may be formed from the material 1004 to dampen sound produced in response to movement (e.g., rattling) of those components in place, or in response to interaction with other components (e.g., as components move relative to one another).

As should be apparent from the above description, the construction of one or more components of the illustrative jalousie 1000 (i.e., from the material 1004) facilitates, enables, or is otherwise associated with, noise reduction without the incorporation of entirely plastic components to dampen sound. That is, the jalousie 1000 does not include or require relatively soft (e.g., entirely plastic) components to be located along one or more paths of motion to effect noise reduction. Instead, one or more components of the jalousie 1000, which may be formed entirely from metal by stamping techniques in conventional configurations, are constructed from the material 1004 to reduce noise as described above

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. Hardware for a door, the hardware comprising:
at least one component formed from a material configured to dampen sound produced during use of the hardware; and
wherein the material includes at least one polymeric layer arranged between multiple metallic layers.

2. The hardware of claim 1, wherein the hardware is a latch assembly and the material includes sound dampening steel.

3. The hardware of claim 1, further comprising:
a second component;
wherein one of the at least one component and the second component is a stationary component and the other of the at least one component and the second component is movable relative to the stationary component;
wherein the material is configured to dampen sound produced in response to interaction between the stationary component and the component movable relative to the stationary component in use of the hardware; and
wherein the material includes sound dampening steel.

4. The hardware of claim 3, wherein the stationary component is a retainer or retaining plate.

5. The hardware of claim 4, wherein the component movable relative to the stationary component is a latchbolt that is movable relative to the retainer or retaining plate between a retracted position in which a portion of the latchbolt is spaced from the retainer or retaining plate, and an extended position in which the portion of the latchbolt contacts the retainer or retaining plate.

6. The hardware of claim 5, wherein the retainer or retaining plate is formed from the material.

7. The hardware of claim 6, wherein the hardware is a cylindrical latch assembly.

8. The hardware of claim 6, wherein the hardware comprises one of the following: a mortise latch assembly, a tubular latch assembly, an interconnected latch assembly, a rim latch assembly, or a cabinet latch assembly.

9. The hardware of claim 6, further comprising a third component formed from the material.

10. An exit device assembly for a door, comprising:
at least one component formed from a material configured to dampen sound produced during use of the exit device assembly; and
wherein the material includes at least one polymeric layer arranged between multiple metallic layers.

11. The exit device assembly of claim 10, wherein the material includes sound dampening steel.

12. The exit device assembly of claim 10, further comprising:
a second component;
wherein one of the at least one component and the second component is a stationary component and the other of the at least one component and the second component is movable relative to the stationary component;
wherein the material is configured to dampen sound produced in response to interaction between the stationary component and the component movable relative to the stationary component in use of the exit device assembly; and
wherein the material includes sound dampening steel.

13. The exit device assembly of claim 12, wherein the stationary component is included in or coupled to a bracket.

14. The exit device assembly of claim 13, wherein the component movable relative to the stationary component is a latchbolt that is movable relative to the bracket between a retracted position in which the latchbolt has a first orientation relative to the bracket, and an extended position in which the latchbolt has a second orientation relative to the bracket different from the first orientation.

15. The exit device assembly of claim 14, wherein the bracket is formed from the material.

16. The exit device assembly of claim 15, further comprising a third component formed from the material.

17. A jalousie, comprising:
at least one component formed from a material configured to dampen sound produced during use of the jalousie; and
wherein the material includes at least one polymeric layer arranged between multiple metallic layers.

18. The jalousie of claim 17, wherein the material includes sound dampening steel.

19. The jalousie of claim 17, further comprising:
a stationary component separate from the at least one component;
wherein the at least one component includes a plurality of components that are movable relative to the stationary component and formed from the material;
wherein the material is configured to dampen sound produced in response to interaction between the stationary component and the plurality of components in use of the jalousie,; and
wherein the material includes sound dampening steel.

20. The jalousie of claim 19, wherein the plurality of components include slats or blades that are pivotally coupled to the stationary component; and
wherein the slats or blades are formed from the material.
